(19) United States
(12) Patent Application Publication
(10) Pub. No.: US 2013/0275368 A1
(43) Pub. Date: Oct. 17, 2013

(54) Maintaining Electrical Vehicle Recharging Station Data

(71) Applicants: Esteban Camacho, Belleville, MI (US); Dexter C. Lowe, Sterling Heights, MI (US); Shpetim S. Veliu, Livonia, MI (US)

(72) Inventors: Esteban Camacho, Belleville, MI (US); Dexter C. Lowe, Sterling Heights, MI (US); Shpetim S. Veliu, Livonia, MI (US)

(73) Assignee: General Motors LLC, Detroit, MI (US)

(21) Appl. No.: 13/446,050

(22) Filed: Apr. 13, 2012

(51) Int. Cl. G06F 17/30

(52) U.S. Cl. 707/609; 707/E17.005

(57) ABSTRACT

Maintaining an electricity powered vehicle recharging database is described where updating is based on recharging information provided by a subscriber via a telematics unit on the electric vehicle relating to a recharge event. Maintaining the database is carried out by receiving an indication that a recharge event has occurred, receiving additional information pertaining to the recharge event, comparing the recharge event information with recharge information for a previous recharge event stored in the database. Based upon the received information and comparison to existing information stored in the database, the received, information is used to conditionally update the information maintained in the database maintained by the telematics service provider.

### TECHNOLOGY FIELD

The present disclosure relates generally to telematics systems and more specifically to using telematics systems within electricity driven vehicles to maintain a database of public recharging stations.

### BACKGROUND

Telematics units within mobile vehicles provide subscribers with connectivity to a telematics service provider (TSP). The TSP provides subscribers with an array of services ranging from emergency call handling and stolen vehicle recovery to diagnostics monitoring and turn-by-turn navigation. Telematics units are provisioned and activated at a point of sale when a subscriber purchases a telematics-equipped vehicle. Upon activation, the telematics unit provides a subscriber with a wide variety of telematics services.

The telematics services provide, among other things, information regarding businesses and amenities located in the vicinity of the user. For example, a TSP permits users to request the location of fuel providers located within the vicinity of the users. To facilitate providing such information to users, a TSP obtains maps and information regarding businesses and amenities from third party information aggregators. However, third party aggregators may not have a sufficient validation process and thereby allow inaccurate information to be passed to the TSP and on to its users. Furthermore, third party aggregators may not update the provided information as frequently as desired for provide users of telematics units with reliable information.

The value of different types of information decays at different rates, information that becomes outdated (and thus less valuable) only through the occurrence of costly or infrequent events decays slower than information that may be affected by the occurrence of frequent events. For example, the value of information pertaining to the location of roads and travel routes becomes outdated and less valuable to the consumer (i.e., decays) upon closure of a road, construction of a new road, or some other event affecting the physical ability of a driver to navigate from one point to another via such roads. In contrast, information pertaining to traffic on the same route decays rapidly since traffic conditions potentially change from minute to minute and/or vary significantly from one day to the next (weekday/weekend). Similarly, fuel providers, restaurants, and other business locations are not likely to decay rapidly as only closing an establishment or constructing a new establishment impacts the value of such information. However, information concerning goods or services pricing or goods and services offerings provided by businesses will become stale much more quickly.

Where it is highly desirable to provide information concerning the price or availability of goods or services, TSPs may not be able to adequately serve their subscribers by providing information obtained from third party information providers. Thus, for certain information, it is potentially advantageous for telematics units to provide up-to-date information to the TSP and thus enable the TSP to provide up-to-date information to all subscribers. For example, the price of gas charged by stations needs to be updated fairly regularly to aid recipients of such information. Where the potential consumer has a lot at stake, such as a significant amount of time, or where procuring an alternative requires considerable cost, such as the loss of an opportunity, the need for up-to-date information is even greater.

### SUMMARY OF THE INVENTION

In the case of an electric vehicle that requires a considerable amount of time to be recharged, information regarding the capacity of a commercial recharging station is valuable to potential customers. Services conventionally provided by TSPs are harnessed to provide telematics system users with up-to-date information relating to commercial recharging stations. TSPs identify the location of a user's vehicle through the provision of Global Positioning System (GPS) navigation services. Moreover, by providing turn-by-turn directions, TSPs provide exact driving directions instructing the user how to reach a specified location. Sensors connected to a vehicle's telematics system enable current diagnostics information to be communicated from a vehicle to the TSP. The TSP monitors the vehicle's sensors via the telematics unit to identify a recharging event and trigger a request for additional information upon detecting the recharging event at a commercial recharging station. The additional information includes, for example, the location of the recharging station, the throughput and/or power output of the of the recharging station, the price paid per unit charge, the hours of operation of the station, the station's customer flow, the vehicle capacity of the station, and other information relating to recharging the electric vehicle. The recharging station information is thus updated by a population of telematics service subscribes without imposing upon the users to provide commercial recharging station information. Moreover, the accumulated recharging station information is available for use by all the TSP subscribers.

Implementations of the present invention contemplate harnessing the communication capabilities of telematics systems to provide users of services provided by such systems with up-to-date information regarding the location, availability, and other information relating to recharging stations for electric vehicles. A method is described for maintaining a recharging database containing information updated based on recharge information provided by a population of electric vehicles having activated telematics units. Maintaining the database is carried out by the TSP by carrying out the steps of receiving an indication that a recharge event has occurred; receiving additional information pertaining to the recharge event; comparing the recharge event information with recharge information for a previous recharge event stored in the database. Based upon the received information and comparison to existing information stored in the database, the received information is used to conditionally update the information maintained in the database maintained by the TSP.

In an implementation, in a particular implementation, the TSP determines whether the recharging station is a commercial site, and stores the received recharging event information upon confirming that: the recharging event information pertains to a commercial recharging station.

In a further implementation, the present invention is implemented as a system including a server and computer-executable instructions stored on a tangible, non-transitory computer-readable medium and a telematics unit.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an operating environment for a mobile vehicle communication system usable in implementations of the described principles;

FIG. 2 is a summary of a set of fields contained in an exemplary information transmission containing information pertaining to a recharging event;

FIG. 3 is a flow chart summarizing steps for an exemplary method for maintaining a recharging station database comprising information pertaining to recharging events;

FIG. 4 is an exemplary set of fields for a database record entry for a par recharging station; and

FIG. 5 is a flow chart identifying steps for an exemplary method for updating information pertaining to recharging events stored in a database.

### DETAILED DESCRIPTION OF THE DRAWINGS

Before discussing the details of the invention and the environment wherein the invention may be used, a brief overview of an exemplary telematics system is given to guide the reader. In general terms, not intended to limit the claims, the invention is directed to a system and method for maintaining a recharging station database that is updated used on a population of electric vehicles equipped with telematics units providing information relating to the vehicles' recharging. Information relating to commercial electric vehicle recharging stations is maintained in the recharging station database. Information relating to recharging events at private recharging facilities is not stored in the recharging station database. Instead such information is either re-directed to a personal database maintained for individual subscribers (e.g., to identify potential maintenance issues such as a dying battery) or not stored at all. A decision to discard recharging information relating to a private recharging station can occur al the vehicle itself or alternatively by the TSP upon detection that the provided information relates to a private recharging station.

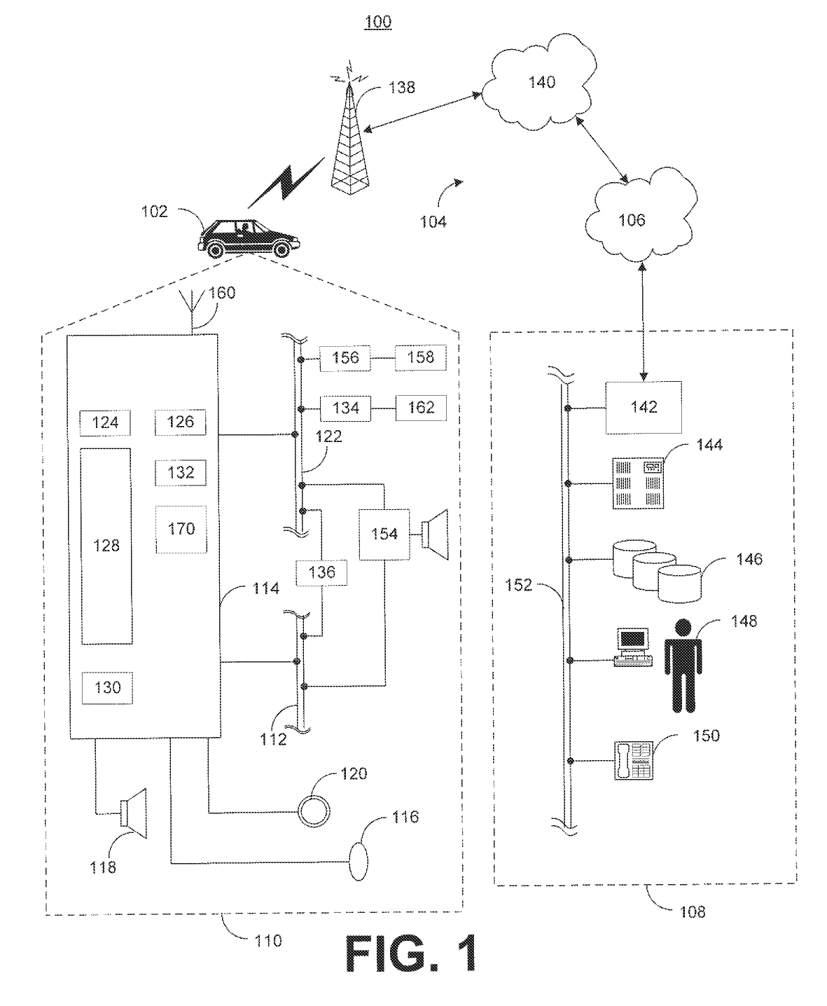

FIG. 1 schematically depicts an exemplary environment for carrying out the invention. It will be appreciated that the described environment is an example, and does not imply any limitation regarding the use of other environments to practice the invention. With reference to FIG. 1 there is shown an example of a communication system 100 that may be used with the present method and system and generally includes a vehicle 102, as wireless carrier system 104, a land network 106 and a call center 108. It should be appreciated that the overall architecture, setup and operation, as well as the individual components of a system such as that shown in FIG. 1 are generally known in the art. Thus, the following paragraphs provide a brief overview of one such exemplary information system 100; however, other systems could employ die present method as well.

Vehicle 102 is a mobile vehicle such as a motorcycle, car, truck, recreational vehicle (RV), boat, plane, etc., and is equipped with suitable hardware and software that enables it to communicate over system 100. The vehicle 102 is, in particular, driven by an electric motor that periodically requires recharging. Additionally, vehicle hardware 110 shown generally in FIG. 1 includes: a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device providing a variety of services through its communication with the call center 108, and generally includes an electronic processing device 128, one or more types of electronic memory 130, a cellular chipset/component 124, a wireless modem 126, a dual antenna 160 and a navigation unit containing a GPS chipset/component 132. In one example, the wireless modem 126 comprises, and is carried out in the form of, a computer program and/or set of software routines executing within the electronic processing device 128. The cellular chipset/component 124 and the wireless modem 126 may be called the network access device (NAD) of the telematics unit 114. The NAD 114 further includes a short-range wireless unit 170 capable of communicating with a user's mobile device such as a cellular phone, tablet computer, PDA, or the like, over a short-range wireless protocol. For example, in one implementation, the short-range wireless unit 170 is a Bluetooth unit with an RF transceiver that communicates with a user's mobile device using Bluetooth protocol.

The short-range wireless unit 170 is adapted to communicate with communication devices maintained by a recharging station to provide information relating to a vehicle recharging event. For example, in an implementation, the short-range wireless unit 170 is a Bluetooth unit with an RF receiver that communicates with a recharging station using Bluetooth protocol. It will be appreciated that other short-range wireless communication technologies other than Bluetooth are used in other implementations. The information provided by the recharging station to the telematics unit via the short-range wireless unit 170 is passed to a server adapted to maintain a database of recharging event information maintained by the TSP.

The telematics unit 114 provides a variety of services for subscribers. Examples of such services include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle.

GPS navigation services are implemented based on the geographic position information of the vehicle provided by the GPS based chipset/component 132. A user of the telematics unit enters a destination using inputs corresponding to the GPS component, and a route to a destination is calculated based on the destination address and a current position of the vehicle determined at approximately the time of route calculation. Turn-by-turn (TBT) directions may further be provided on a display screen corresponding to the GPS component and/or through vocal directions provided through a vehicle audio component 154. It will be appreciated that the calculation-related processing may occur at the telematics unit or may occur at a call center 108.

Infotainment-related services are provided by the TSP wherein music, Web pages, movies, television programs, video games and/or other content is downloaded to an infotainment center 136 operatively connected to the telematics unit 114 via a vehicle bus 122 and an audio bus 112. In one example, downloaded content is stored for current or later playback,

Again, the above is by no means an exhaustive list of all the capabilities of telematics unit 114, as should be appreciated by those skilled in the art, but is simply an illustration of some of the services that the telematics unit 114 oilers. The telematics unit 114 includes a number of known components in addition to those described above.

Vehicle communications use radio transmissions to establish a communications channel within the wireless carrier system 104 so that, voice and/or data transmissions occur over the communications channel. Vehicle communications are enabled via the cellular chipset/component 124 for voice communications and a wireless modem 126 for data transmission.

To enable successful data transmission over the communications channel, wireless modem 126 applies some form of encoding or modulation to convert the digital data so that it can communicate through a vocoder or speech codec incorporated in the cellular chipset/component 124. Any suitable encoding or modulation technique that provides an acceptable data rate and hit error can be used with the present method Dual mode antenna 160 services the UPS chipset/component and the cellular chipset/component.

The microphone 116 provides the driver or other vehicle occupant with a means for inputting verbal or other auditory commands, and can be equipped with an embedded voice processing unit utilizing a human/machine interface (HMI) technology known in the art. Conversely, the speaker 118 provides verbal output to the vehicle occupants and can he either a stand-alone speaker specifically dedicated for use with the telematics unit 114 or can be part of a vehicle audio component I 54. In either event, the microphone 116 and the speaker 118 enable vehicle hardware 110 and the call center 108 to communicate with the occupants through audible speech.

The vehicle hardware also includes one or more buttons or controls 120 configured to enable a vehicle occupant to activate or engage one or more of the vehicle hardware components 110. For example, one of the buttons 120 is an electronic push button that, when pressed, initiates voice communication with a call center 108 (whether it be a live advisor 148 or an automated call response system). In another example, one of the buttons 120, when pushed, initiates emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. The audio component 154 contains a speaker system, or alternatively utilizes the speaker 118 via arbitration on vehicle bus 122 and/or audio bus 112.

The vehicle crash and/or collision detection sensor interface 156 is operatively connected to the vehicle bus 122. The crash sensors 158 provide information to the telematics unit 114 via the crash and/or collision detection sensor interface 156 regarding, the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, the wireless carrier system 104 includes one or more cell towers 138, base stations and/or mobile switching centers (MSCs) 140, as well as any other networking components required to connect the wireless system 104 with land network 106. A component in the mobile switching center may include a remote data server.

As appreciated by those skilled in the art, various cell tower/base station/MSC arrangements are possible and could be used with the wireless system 104 (also referred to as the “cellular network” herein). For example, a base station and a cell tower could be co-located at the same site or they could be remotely located, and a single base station could be coupled to various cell towers or various base stations could be coupled with a single MSC, to name but a few of the possible arrangements. Preferably, a speech codec or vocoder is incorporated in one or more of the base stations, but depending on the particular architecture of the wireless network, it could be incorporated within a Mobile Switching Center or some other network components as well.

The land network 106 is, for example, a conventional land-based telecommunications network connected to one or more landline telephones and connecting wireless carrier network 104 to call center 108. For example, land network 106 includes a public switched telephone network (PSTN) and/or an Internet protocol (IP) network, as is appreciated by those skilled in the art. Of course, one or more segments of the land network 106 are implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144 (including a server adapted to communicate with telematics units to receive recharging station information and adapted to provide recharging station information previously tabled in a database maintained by the call center 108), databases 146 (including a database adapted to maintain the recharging station information described herein provided to the server by a population of electric vehicles), live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modern or other piece of telecommunication and computer equipment 150 for demodulation and further signal processing.

The telecommunication and computer equipment 150 includes a modem that preferably includes an encoder, as previously explained, and can be connected to various devices such as application servers 144 and databases 146. For example, the databases 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

In one example, part of the databases 146 maintains information pertaining to a plurality of recharging stations. Each time a vehicle is recharged, the vehicle sensors 1 through sensor interface modules 134 and operatively connected to the vehicle bus 122, determine that a recharging event is taking place or has just occurred and that the vehicle has been recharged. Upon determining that a recharging event is taking place, the telematics unit 114 receives and monitors information pertaining to the recharging event from the vehicle sensors 162. For example, through vehicle sensors 162 and sensor interface modules 134, the telematics unit can determine the times at which a recharging event begins and ends and the charge level of the vehicle's battery during the recharging event. In this way, during the charging event, the telematics unit may acquire, as functions of time, the electric current passing through the charging paddle into the battery, the charge level of the battery, and other measurements related to the recharging event. The telematics unit 114 may also request additional information pertaining to the recharging event from other elements of the vehicle hardware 110. For example, the navigation unit containing a UPS based component may identify the current location of the vehicle. Depending upon the type of connection the vehicle is able to achieve with the recharging station, additional information originating from the recharging station is obtained by the telematics unit 114. This information includes the throughput and power output of the of the recharging station, the price paid per unit (e.g., kW hour) for recharging, the hours of operation of the commercial recharging station, the station's customer flow, the vehicle capacity of the station, the identity of the specific paddle to which the vehicle is connected, and other information related to the recharging event.

In another example, the telematics unit 114 comprises additional communication hardware that enables the telematics unit 114 to communicate with compatible communication equipment at the recharging station. For example, upon receiving an indication from the vehicle sensors 162 that a recharging event is occurring, the telematics unit seeks to connect with external devices supported and maintained by a recharging station. A communication link between these external devices and the telematics unit is provided over a short-range wireless technology such as Bluetooth, Wi-Fi, ZigBee, and RFID amongst others. The telematics unit requests a variety of information from the external devices including but not limited to the throughput and power output of the of the recharging station, the price paid per unit (e.g., kW hour) during recharging, the hours of operation of the station, the station's customer flow, the vehicle capacity of the station, and other information related to the recharging station. The telematics unit 114 may also merely request a connection with the external device and passively receive information from the device or the telematics unit may passively receive a request for a connection from the external de⁻vice example., the telematics unit may be able to identify external devices maintained by a recharging station and attempt to connect with such devices upon becoming in range or the external device may identify and attempt to connect to all telematics units that come within its range. Upon receipt of any such information from the external device, the telematics unit 114 aggregates information pertaining to the recharging event and sends it to the call center 108 (e.g., the servers 144 and databases 146) where it is processed. Alternatively, communication equipment at the recharging station sends information to the call center 108 and thereby communicates directly with the servers 144 and databases 146. In this manner, information is sent to the servers 144 and databases 146 upon completion of the recharging event.

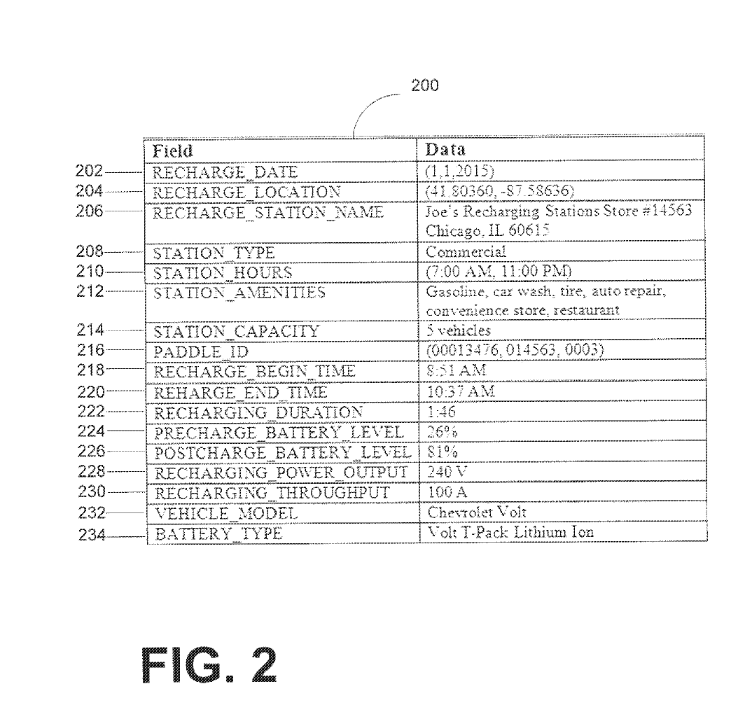

FIG. 2 provides an exemplary set of fields of information contained in a transmission, summarizing a recharging event, included in a communication to the servers 144 and databases 146. The information contained in the transmission originates from the vehicle sensors 162 and sensor interface modules 134 or, alternatively, from equipment at the recharging station when the recharging occurred. The transmission is sent from the telematics unit 114 or, alternatively from communication equipment at the recharging station. In the exemplary information transmission 200, a RECHARGE_DATE field 202 contains information pertaining to the date on which the recharging event took place. In this example, the RECHARGE_DATE 202 field is a data structure with elements for the month, day, and year on which the recharging event took place. A RECHARGE_LOCATION 204 provides the geographical coordinates at which the recharging event occurred and in the exemplary transmission is a data structure with elements for the latitude coordinate and longitude coordinate. A RECHARGESTATION_NAME 206 provides the name of the recharging station and a STATION_TYPE 208 indicates whether the station is a residential location, commercial location, or some other category of recharging location. A STATION_HOURS field 210 provides the hours of operation of the recharging station and in the exemplary information transmission is a data structure with elements for the time at which the recharging station opens and for the time at which the station closes. A STATION_AMENITIES 212 lists other goods and services that the recharging, station and businesses affiliated with the recharging station provides. For example, if recharging paddles (outlets) are located at a supermarket parking lot, the STATION_AMENITIES 212 indicates that a supermarket is located at the recharging station. A STATION_CAPACITY 214 indicates a number of recharging paddles located at the identified recharging station. A PADDLE_ID field 216 provides a unique identifier for the paddle at which the recharging event occurred. In the exemplary transmission, the PADDLE_ID field 216 is a data structure with an identifier of the owner of the recharging station, an identifier of the particular charging station where the recharging event occurred, and an identifier of the particular paddle used by the vehicle at the recharging station. A RECHARGE _BEGIN_TIME 218, a RECHARGE_END_TIME 220, and a RECHARGING_DURATION 222 indicates the time at which the vehicle began recharging, the time at which the recharging event ended, and the length of time the vehicle spent recharging. A PRECHARGE_BATTERY_LEVEL 224 and a POSTCHARGE_BATTERY_LEVEL 226 indicate the battery charge level before and after the recharging event. A RECHARGING_POWER_OUTPUT field 228 indicates the power output of the recharging paddle and a RECHARGING _THROUGHPUT 230 indicates a maximum throughput the identified recharging paddle is capable of producing. A VEHICLE_MODEL 232 and a BATTERY_TYPE 234 indicate a manufacturer and a model of the vehicle and battery that engaged in the recharging event.

It will be appreciated that FIG. 2 is not an exhaustive list, nor does it constitute a list of required fields. Many other fields may be included in a database record, and some of the fields listed below might not be included. Moreover, some of the fields included in the exemplary table may take the form of different data structures or data types. For example, the RECHARGE_BEGIN_TIME, the RECHARGE_END_TIME, the RECHARGING_DURATION, the RECHARGING_THROUGHPUT, and the battery levels could be transferred in a single data structure where data points for each field were obtained at a high frequency, e.g. 1 kHz. At a frequency of 1 kHz, 3.6 million data points for the recharging throughput and battery levels during a 1 hour recharging event. The frequency at which data points are obtained could be adjusted to achieve an optimal balance between monitoring the pace of recharging and dealing with data storage limitations.

After receiving information from vehicle sensors, external devices, or both, the telematics unit 114 sends information pertaining to the recharging event through the dual mode antenna 160, the wireless carrier network 104, and the land network 106 to the call center 108. The call center 108 contains a variety of servers 144 and databases 146 adapted and configured to receive, process and maintain the information pertaining to the recharging event sent from either the telematics unit 114 or from communication equipment at the recharging station.

Upon receipt of the information pertaining to a recharging event, the servers 144 and/or databases 146 process the content of the information received from the telematics unit 114. The servers 144 determine the recharging station at which the recharging event occurred and query the databases 146 to determine whether a record exists for a recharging event occurring at that recharging station. In the event that a record exists for a previous recharging event at the same recharging station, the servers 144 request additional information from the databases 146 pertaining to the prior recharging event. The servers 144 then compare the new information from the telematics unit 114 with the information relating to a previous recharging event retrieved from one of the databases 146. Based upon the comparison, the servers 144 determine whether the previously stored information, retrieved from the databases 146, has become stale (out-of-date).

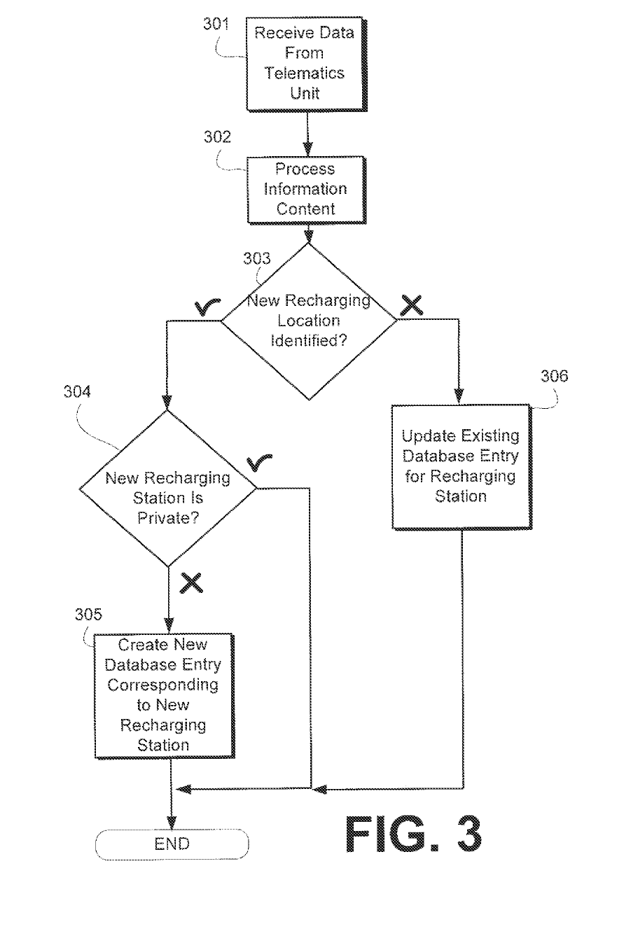

Turning to FIG. 3, data from the telematics unit 114 is received by the call center 108 at step 301. At step 302, the content of the information received by the call center from the telematics unit is processed. The processing is performed by the servers 144 and includes analyzing the information stored in the database 146 relating to accumulated recharging station event information maintained by the TSP for purposes of maintaining up-to-date information regarding the performance and capabilities of commercial recharging stations. For example, the databases 146 include a listing of recharging stations indexed by unique location (e.g., GPS coordinates). The servers 144 identify the recharging station at which the recharging event occurred, for which data from the telematics unit 114 was received at step 301.

At step 303, the servers 144 identify whether the data received during step 301 relates to a new recharging station or a recharging station that was identified in a recharging event record previously stored in the database 146. If the servers 144 determine that a new recharging station has been identified in received recharging event information, then control proceeds from step 303 to step 304. In the described example, the databases 146 are populated with information relating to recharging stations that are available for use by subscribers. Therefore, at step 304 the servers 144 determine whether the recharging event occurred at a private recharging station (e.12, individual residence). During step 304, the servers 144 initially confirm that the throughput and power output of the identified recharging station satisfies certain threshold conditions indicative of a commercial recharging station. For example, if the throughput and power output of the recharging station does not exceed a certain specified threshold (e.g., voltage or maximum current/power), then the servers 144 conclude that the recharging station is not a commercial recharging station and is instead a private recharging station. Additionally, the determination at step 304 is augmented by the servers 144 referencing the information stored in a customer database to confirm that the location of the recharging station at which the recharging event occurred is not a recharging station/location that a customer has indicated to be a private residential address. Additionally, the servers 144 reference information indicating residential areas to determine, whether the recharging station is in a residential location and therefore a private station. If the recharging station is a private station, then control passes from step 304 to the End, and the servers 144 do not create a new entry in the database 146 for a recharging station corresponding to the recharging event information received from the telematics unit 114 during step 301.

On the other hand, if the recharging station is determined to be a commercial recharging station then control passes from step 304 to step 305. During step 305, the servers 144 submit a request to the databases 146 to create a new database entry corresponding to the new commercial recharging station at 305. The database entry maintained in the databases 146 for a recharging station includes fields for a variety of information that may have been aggregated and sent by the telematics unit. The fields in the database entry for each recharging station may include: throughput and power output, hours of operation, customer flow, number of paddles, etc. After creating a new recharging station entry in the databases 145, control passes from step 305 to the End.

If at step 303 the servers 144 determine that the data received at step 301 pertains to a recharging station that was previously stored in the database, the servers 144 update the database entry according to the information received from the telematics unit at 306. Control then passes to the End.

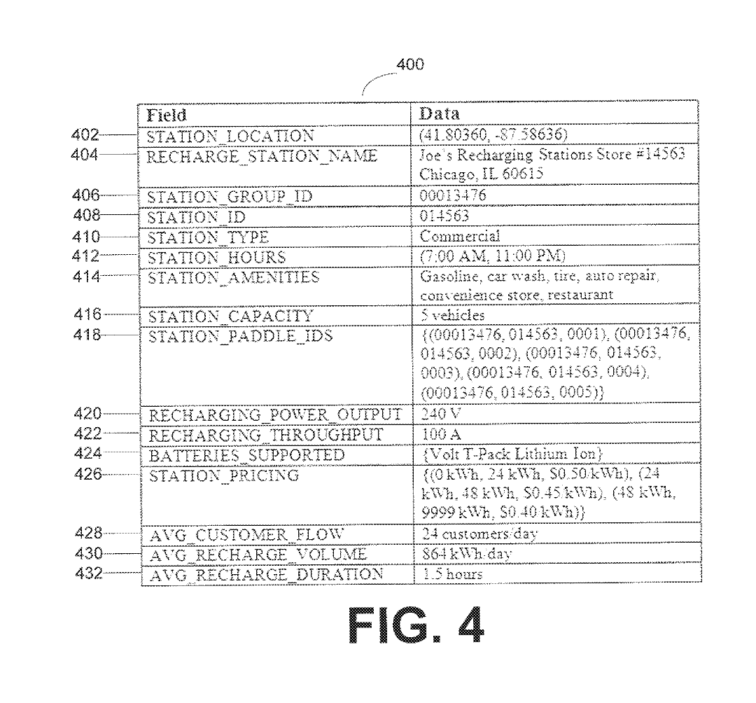

FIG. 4 provides an exemplary set of fields for a database entry for a record for a recharging station. In the exemplary database entry 400, a STATION_LOCATION field 402 provides geographical coordinates where a recharging station is located. In the exemplary entry, the STATION_LOCATION field 402 is a data structure with elements for the latitude and longitude. A RECHARGING_STATION_NAME 404 provides the name of the recharging station to which the information in the database entry pertains, A STATION_GROUP_ID 406 and a STATION_ID 408 contain unique identifiers for a group to which the recharging station belongs and for the particular recharging station itself A STATION_TYPE 410 details whether the station is a residential location, commercial location, or some other category of location. A STATION_HOURS field 412 provides hours of operation of the recharging station, and in the exemplary entry a data structure includes elements for a time at which the recharging station opens and for a time at which the recharging station closes, A STATION_AMENITIES field denotes other goods and services which are provided by the station. For example, if the recharging paddies are located in the parking lot of a shopping center, the database record might list an electronics store, a shoe store, a restaurant, and a supermarket in the STATION_AMENITIES field. A STATION_CAPACITY indicates the total number of vehicles that can be simultaneously charged at the charging station, or if equivalent, the number of charging paddles located at the station, A STATION_PADDLE_IDS field 418 provides a list of unique identifiers for each of the recharging paddles at the recharging station. In the exemplary entry, each paddle ID is a data structure with elements for the recharging station group identifier, the recharging station identifier, and an identifier for the individual paddle. A RECHARGING_POWER_OUTPUT 420 and RECHARGING_THROUGHPUT 422 provide information regarding the power output and throughput of the recharging paddles located at the recharging station. A BATTERIES_SUPPORTED 424 indicates which battery models can be recharged at the recharging station and a STATION_PRICING field 426 indicates the price of using the recharging station. An AVG_CUSTOMER_FLOW field 428 indicates the average number of customers that patronize the recharging station, an AVG_RECHARGE_VOLUME 430 indicates the average aggregate amount of electricity consumed by patrons of the recharging station, and the AVG_RECHARGE_DURATION 432 indicates average length of time patrons of the recharging station spend recharging their vehicles.

It will be appreciated that this is not an exhaustive listing of fields for a recharging station database entry, nor does it constitute a list of required fields. Many other fields may be included in a database record, and some of the fields listed below might not he included. Furthermore, the information included in the fields described in the exemplary database entry may be indexed differently. For example, a database entry for a recharging station may include a number of data structures for individual paddles that include information which may vary amongst different paddles located at a particular recharging station. Paddle data structures might include fields for recharging, power output, recharging throughput, batteries supported, and price charged.

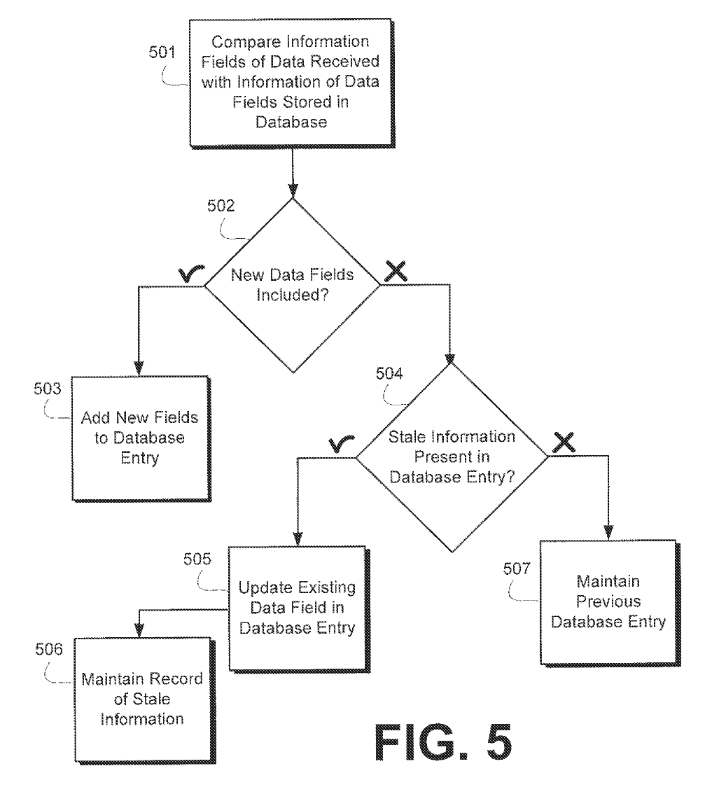

FIG. 5 summarizes detailed steps associated with conditionally updating a database entry, for a recharging station that already exists in the databases 146, with new recharging event information during step 306. With reference to FIG. 5, at step 501 the servers 144 update the existing database entry by comparing the data fields in the data received at step 301 with data fields in a corresponding entry in the database 146. At step 502, the servers 144 determine whether the data received at step 301 by the call center 108 contains data fields that were not previously included in the database entry. If the data received by the call center 108 contains new data fields, then control passes from step 502 to step 503 wherein the servers 144 request the databases 146 to add new fields to the database entry for an identified recharging station. For example, if data received at 301 includes information pertaining to the recharging station's hours of operation or the recharging station's vehicle recharging schedule, and the database entry contains no information pertaining to these fields, then the servers 144 will request the databases 146 to add these fields to the database entry at step 503.

If, at step 302, the servers 144 determine that the databases 146 contain field entries corresponding to the data received at step 301, then control passes to step 504. At step 504 the servers 144 determine whether the database entry contains information that has become stale in light of the additional information received at 301. If the information is not stale, then control passes to step 507, and the current information is maintained for the database entry. If the information is stale for the identified recharging station in view of the received information, then control passes from step 504 to step 505.

At step 505 the servers 144 submit requests to the databases 146 to update the information stored in the databases 146 for an identified recharging station to reflect the up-to-date information received from the telematics unit 114.

During step 504, any number of data fields stored in the databases 146 may be analyzed to determine whether information currently stored in the databases 146 has become stale. For example, the databases 146 may include information pertaining to the throughput and power output of the of the recharging station, the hours of operation of the station, the station's customer flow, the vehicle capacity of the station, and other information related to the recharging station. The servers 144 compare such information stored in the database 146 with up-to-date information received during step 301 from the telematics unit 114. If the database entry contains stale information, the servers 144 update the existing data fields in the database entry. For example, if the database indicates that the recharging station has the capacity to recharge three additional vehicles on Jul. 3, 2015 between 9:00 AM and noon, and the information received during step 301 indicates that the recharging station has no capacity to recharge additional vehicles on Jul. 3, 2015 between 9:00 AM and noon, the servers 144 will update the entry in the databases 146 to reflect that the recharging station has no capacity to recharge additional vehicles at that particular time. Similarly, if the database 146 has stored information determining that the price paid per unit is $0.10/kWh and the servers 144 determines that the telematics unit 114 indicates that the recharging station is now recharging $0.11/kWh, the servers 144 determines that the information stored in the database 146 is not up-to-date. The not up-to-date information currently stored in the database 146 may be overwritten by the servers 144.

Additionally, at 506, the servers 144, rather than delete the stale information entirely, archive the previous values for the recharging station. Alternatively, the stale information is left in the present database and a new record entry is created for the newest information received for an identified recharging station. In this manner, the databases 146 store data obtained from a variety of recharging stations over a period of time and record the maimer in which such data has fluctuated over a given period of time.

It will be appreciated 1w those of skill in the art that the information exchanged between the user, the call center, and the recharging station may vary in content. For example, the call center may have the authority to schedule a recharging event on behalf of the user without allowing the user to select amongst appropriate recharging stations. In such an embodiment, the call center may select the recharging station that is the best match based upon the criteria selected by the user.

It will be appreciated by those of skill in the art that the execution of the various machine-implemented processes and steps described herein may occur via the computerized execution of computer-executable instructions stored on a tangible computer-readable medium, e.g., RAM, ROM, PROM, volatile, nonvolatile, or other electronic memory mechanism. Thus, for example, the operations performed by the telematics unit may be carried out according to stored instructions or applications installed on the telematics unit, and operation performed at the call center may be carried out according to stored instructions or applications installed at the call center.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for maintaining a recharging station database for electricity powered vehicles based upon recharging event data provided by a population of electric vehicles equipped with telematics units, the method comprising the steps of:
receiving, by a telematics server, recharging event information corresponding to a recharging event at an identified recharging station; and
if an entry corresponding to the identified recharging station cannot he identified in the recharging station database, then creating a new database entry for the identified recharging station.

2. The method of claim 1, wherein the recharging event information comprises a start time and a finish time of the recharging event, charge levels of a battery before and after the recharging event, and one of a type of vehicle and a type of battery recharged, farther comprising:
calculating the throughput based on the duration of the recharging event and the relative charge level of the vehicle before and after the recharging event.

3. The method of claim 1, wherein the recharging event information comprises a start time and a finish time of the recharging event, charge levels of a battery before and after the recharging event, and one of a type of vehicle and a type of battery recharged, further comprising:
calculating the power output based on the duration of the recharging event and the relative charge level of the vehicle before and after the recharging event.

4. The method of claim 2, further comprising:
determining, based on the throughput of the recharging station, whether the recharging station is a residential location.

5. The method of claim 3, further comprising:
determining, based on the power output of the recharging station, whether the recharging, station is a residential location,

6. The method of claim 1, further comprising:
cross-referencing a database containing customer information to determine whether the recharging event occurred at a customer's address.

7. The method of claim 1, further comprising:
determining whether the recharging event occurred at a residential location by cross referencing a database containing land zoning information.

8. The method of claim 1, wherein the recharging event information comprises a type of battery being recharged and charge levels of the battery at multiple times during the recharging event, further comprising:
determining the throughput and power output during the recharging event by calculating a rate of change of the battery charge level during the recharging event.

9. The method of claim 1, wherein the recharging event information comprises one or more of a time at which the recharging event occurred, hours of operation of the recharging station, a number of recharging paddles at the recharging station, a duration of the recharging event, a battery charge level, battery information a name of the recharging station, an identifier of the recharging station, an identifier of a recharging paddle, and information regarding the recharging station's offerings.

10. The method of claim 1 wherein the information stored in the new database entry comprises one or more of a location of the recharging station, a name of the recharging station, an identifier of the recharging station, an identifier of a group to which the recharging station belongs, identifiers of one or more recharging paddles located at the recharging station, hours of operation of the recharging station, hours of operation of one or more paddles located at the recharging station, power output of one or more paddles located at the recharging station, throughput of one or more paddles located at the recharging station, prices charged by the recharging station, batteries supported by the recharging station, batteries supported by one or more paddles located at the recharging station, an average number of patrons using the recharging station per unit time, an average amount of electricity consumed at the recharging station per unit time, and an average duration of recharging events occurring at recharging station.

11. A method for maintaining a recharging station database for electricity powered vehicles based upon recharging event data provided by a population of electric vehicles equipped with telematics units, the method comprising the steps of:
receiving, by a telematics server, recharging event information corresponding to a recharging event;
based on the recharging event information, identifying a recharging station where the recharging event occurred for which information was previously stored in the d s
comparing, by the telematics server, the recharging event information to information previously stored in the recharging station database for the identified recharging station;
conditionally updating, based upon the comparing step, the recharging station database to include the received recharging information; and
providing, by the telematics server, access to recharging station information stored within the recharging station database.

12. The method of claim 11, wherein the recharging event information comprises a start time and a finish time of the recharging event, charge levels of a battery before and after the recharging event, and one of a type of vehicle and a type of battery recharged, further comprising:
calculating the throughput based on the duration of the recharging event and the relative charge level of the vehicle before and after the recharging event.

13. The method of claim 11, wherein the recharging event information comprises a start time and a finish time of the recharging event, charge levels of a battery before and after the recharging event, and one of a type of vehicle and a type of battery recharged, further comprising:
calculating the power output based on the duration of the recharging event d the relative charge level of the vehicle before and after the recharging event.

14. The method of claim 12, further comprising:
determining, based on the throughput of the recharging station, whether the recharging station is a residential location.

15. The method of claim 13, further comprising:
determining, based on the power output of the recharging station, whether the recharging station is a residential location.

16. The method of claim 11, further comprising:
cross referencing a database containing customer information to determine whether the recharging event occurred at a customer's address.

17. The method of claim 11, further comprising:
determining whether the recharging event occurred at a residential location by cross referencing a database containing land zoning information.

18. The method of claim 11, wherein the recharging event information comprises a type of battery being recharged and charge levels of the battery at multiple times during the recharging event, further comprising:
determining the throughput and power output during the recharging event by calculating a rate of change of the battery charge level during the recharging event.

19. The method of claim 11, wherein the recharging event information comprises one or more of a time at which the recharging event occurred, hours of operation of the recharging station, a number of recharging paddles at the recharging station, a duration of the recharging event, a battery charge level, battery information, a name of the recharging: station, an identifier of the recharging station, an identifier of a recharging paddle, and information regarding the recharging station's offerings.

20. The method of claim 11, wherein the information previously stored in the recharging database fur the identified recharging station comprises one or more of a location of the recharging station, a name of the recharging station, an identifier of the recharging station, an identifier of a group to which the recharging station belongs, identifiers of one or more recharging paddles located at the recharging station, hours of operation of the recharging station, hours of operation of one or more paddles located at the recharging station, power output of one or more paddles located at the recharging station, throughput of one or more paddles located at the recharging station, prices charged by the recharging station, batteries supported by the recharging station, batteries supported by one or more paddles located at the recharging station, an average number of patrons using the recharging station per unit time, an average amount of electricity consumed at the recharging station per unit time, and an average duration of recharging events occurring at the recharging station.

21. The method of claim 20, wherein the conditionally updating the recharging station database to include the received recharging information comprises:
modifying the hours of operation of the recharging station if the recharging event occurred outside the hours of operation,

22. The method of claim 20, wherein the conditionally updating the recharging station database to include the received recharging information comprises:
modifying the hours of operation of uric or more paddies at the recharging station if the recharging event occurred outside the hours of operation.

23. The method of claim 20, wherein the conditionally updating the recharging station database to include the received recharging information comprises:
adding a paddle identifier to the previously stored information if the recharging event information includes a paddle identifier not previously included in the information stored on the database.

24. A non-transitory computer-readable medium including computer executable instructions for maintaining a recharging station database for electricity powered vehicles based upon recharging event data provided by a population of electric vehicles equipped with telematics units, the computer-executable instructions facilitating performing the steps of:
receiving, by a telematics server, recharging event information corresponding to a recharging event at an identified recharging station; and
if an entry corresponding to the identified recharging station cannot be identified in the recharging station database, then creating a new database entry for the identified recharging station.

25. A telematics server comprising:
a processor;
a network interface; and
a non-transient computer-readable medium including computer executable instructions for maintaining a recharging station database for electricity powered vehicles based upon recharging event data provided by a population of electric vehicles equipped with telematics units, the computer-executable instructions facilitating performing the steps of:
receiving, via the network interface, recharging event information corresponding to a recharging event at an identified recharging station; and
if an entry corresponding to the identified recharging station cannot be identified in the recharging station database, when creating a new database entry for the identified recharging station.
